(19) United States
(12) Patent Application Publication
(10) Pub. No.: US 2025/0310860 A1
(43) Pub. Date: Oct. 2, 2025

(54) Dynamic Allocation of Network Slice Limits and On-Demand Network Slices

(71) Applicant: Apple Inc., CUPERTINO, CA (US)

(72) Inventors: Krisztian KISS, Rancho Santa Fe, CA (US); Alosious Pradeep PRABHAKAR, Singapore (SG); Rohit R MATOLIA, Bangalore (IN); Vijay VENKATARAMAN, San Jose, CA (US)

(21) Appl. No.: 18/863,373

(22) PCT Filed: May 3, 2023
(86) PCT No.: PCT/US2023/020778

§ 371 Date: Nov. 6, 2024

(30) Foreign Application Priority Data
May 6, 2022 (IN) 202241026501

(51) Int. Cl. H04W 48/02; H04W 48/18

(52) U.S. Cl. CPC H04W 48/02; H04W 48/18

(57) ABSTRACT

A primary network slice admission control function (NSACF) configured to determine a global quota comprising a first number of user equipments (UEs) or protocol data unit (PDU) sessions that are allowed to be registered to a network slice, receive, from a first local NSACF, an indication of a second number of UEs or PDU sessions currently registered to the network slice by the first local NSACF, wherein the first local NSACF is configured with a first local quota comprising a third number of UEs or PDU sessions that are allowed to be registered to the network slice by the first local NSACF, compare the second number to a local quota usage threshold for the first local NSACF and determine, based on the comparing, whether the first local quota for the first local NSACF is to be updated by decreasing the third number.

### BACKGROUND

A network slice refers to an end-to-end logical network that is configured to provide a particular service and/or possess particular network characteristics. A network operator may want to limit the number of devices registered to a particular network slice. The network may be equipped with a network slice admission control function (NSACF) to perform this task. For example, the NSACF may perform various operations related to managing the number of user equipment (UEs) and/or sessions registered to an individual network slice. However, there may be multiple NSACFs that control access to an individual slice. Thus, there needs to be a manner of enforcing the limits when there are more than one NSACF for a slice.

### SUMMARY

Some exemplary embodiments are related to a primary network slice admission control function (NSACF) configured to perform operations. The operations include determining a global quota comprising a first number of user equipments (UEs) or protocol data unit (PDU) sessions that are allowed to be registered to a network slice, receiving, from a first local NSACF, an indication of a second number of UEs or PDU sessions currently registered to the network slice by the first local NSACF, wherein the first local NSACF is configured with a first local quota comprising a third number of UEs or PDU sessions that are allowed to be registered to the network slice by the first local NSACF, comparing the second number to a local quota usage threshold for the first local NSACF and determining, based on the comparing, whether the first local quota for the first local NSACF is to be updated by decreasing the third number.

Other exemplary embodiments are related to a local network slice admission control function (NSACF) configured to perform operations. The operations include receiving, from an access and mobility control function (AMF), a first update request indicating a first number of user equipments (UEs) or protocol data unit (PDU) sessions currently registered to a network slice by the local NSACF should be incremented, determining the first number of UEs or PDU sessions will exceed a local quota comprising a second number of UEs or PDU sessions that are allowed to be registered to the network slice by the local NSACF and sending, to a primary NSACF, a second update request from a second local NSACF indicating the first number should be incremented.

Still further exemplary embodiments are related to a local network slice admission control function (NSACF) configured to perform operations. The operations include receiving, from a primary NSACF, a request to indicate a first number of user equipments (UEs) or protocol data unit (PDU) sessions currently registered to a network slice by the local NSACF, wherein the local NSACF is configured with a local quota comprising a second number of UEs or PDU sessions that are allowed to be registered to the network slice by the local NSACF and sending, to the primary NSACF, a response indicating the first number.

Additional exemplary embodiments are related to a primary network slice admission control function (NSACF) configured to perform operations. The operations include receiving, from each of a plurality of local NSACFs, a report indicating a first number of user equipments (UEs) or protocol data unit (PDU) sessions currently registered to a network slice by the local NSACF, comparing the first number to a local quota usage threshold for each of the local NSACFs, wherein the local quota usage threshold is based on a local quota for each of the local NSACFs comprising a second number of UEs or PDU sessions that are allowed to be registered to the network slice by a corresponding local NSACF and determining, based on the comparing, whether the local quota for one or more of the local NSACFs is to be updated.

Further exemplary embodiments are related to a processor of a user equipment (UE) configured to perform operations. The operations include receiving, from an access and mobility function (AMF), a list of configured network slices, wherein one or more of the configured network slices are identified as on-demand network slices, evaluating User Equipment Route Selection Policy (URSP) rules to determine if the URSP rules include a Route Selection Descriptor for any of the on-demand network slices, sending, to the AMF, a registration request comprising the on-demand network slices for which the URSP rules include the Route Selection Descriptor, receiving, from the AMF, a registration response comprising a list of allowed network slices and for any on-demand network slices for which the URSP rules include the Route Selection Descriptor and are on the list of allowed network slices, further evaluating the URSP rules related to the on-demand network slices.

### BRIEF DESCRIPTION OF THE DRAWINGS

FIG. 1 shows an exemplary network arrangement according to various exemplary embodiments.

FIG. 2 shows an exemplary network architecture according to various exemplary embodiments.

FIG. 3 shows a first exemplary signaling diagram showing a primary NSACF dynamically reallocating quota to local NSACFs according to various exemplary embodiments.

FIG. 4 shows a second exemplary signaling diagram showing a primary NSACF dynamically reallocating quota to local NSACFs according to various exemplary embodiments.

FIG. 5 shows a third exemplary signaling diagram showing a primary NSACF dynamically reallocating quota to local NSACFs according to various exemplary embodiments.

FIG. 6 shows a signaling diagram illustrating the concept of an on-demand slice according to various exemplary embodiments.

FIG. 7 shows an exemplary UE according to various exemplary embodiments.

### DETAILED DESCRIPTION

The exemplary embodiments may be further understood with reference to the following description and the related appended drawings, wherein like elements are provided with the same reference numerals. The exemplary embodiments introduce enhancements for network slicing. In one aspect, the exemplary embodiments relate to enforcing network quotas for UEs or PDU sessions that may be registered to a network slice. In another aspect, the exemplary embodiments relate to defining an on-demand network slice where a UE only registers with a network slice when it is actually needed to have connectivity to the network slice. Each of these exemplary aspects will be described in detail below.

The exemplary embodiments are described with regard to a user equipment (UE). However, the use of the term “UE” is merely for illustrative purposes. The exemplary embodiments may be utilized with any electronic component that may establish a connection with a network and is configured with the hardware, software, and/or firmware to exchange information and data with the network. Therefore, the UE as described herein is used to represent any suitable electronic component.

The exemplary embodiments are described with regard to a fifth generation (5G) network that supports network slicing. Generally, network slicing refers to a network architecture in which multiple end-to-end logical networks run on a shared physical network infrastructure. Each network slice may be configured to provide a particular set of capabilities and/or characteristics. Thus, the physical infrastructure of the 5G network may be sliced into multiple virtual networks, each configured for a different purpose. Throughout this description, reference to a network slice may represent any type of end-to-end logical network that is configured to serve a particular purpose and implemented on the 5G physical infrastructure.

Those skilled in the art will understand that 5G may support a variety of different use cases, e.g., enhanced mobile broadband (eMBB), enhanced machine type communication (eMTC), industrial internet of things (IIOT), etc. Each type of use case may relate to various different types of applications and/or services. A network slice may be characterized by a type of use case, a type of application and/or service or the entity that provides the application and/or service via the network slice. However, any example in this description that characterizes a network slice in a specific manner is only provided for illustrative purposes. Throughout this description, reference to a network slice may represent any type of end-to-end logical network that is configured to serve a particular purpose and implemented on the 5G physical infrastructure.

A network slice may be identified by single network slice selection assistance information (S-NSSAI). Each instance of S-NSSAI may be associated with a public land mobile network (PLMN) and may include the slice service type (SST) and a slice descriptor (SD). The SST may identify the expected behavior of the corresponding network slice with regard to services, features and characteristics. Those skilled in the art will understand that the SST may be associated with a standardized SST value. The SD may identify any one or more entities associated with the network slice. For example, the SD may indicate an owner or an entity that manages the network slice (e.g., carrier) and/or the entity that the is providing the application/service via the network slice (e.g., a third-party, the entity that provides the application or service, etc.). In some embodiments, the same entity may own the slice and provide the service (e.g., carrier services). Throughout this description, S-NSSAI refers to a single network slice and the terms “NSSAI” or “S-NSSAIs” may be used interchangeably to refer to one or more network slices.

The exemplary embodiments are also described with regard to a network slice admission control function (NSACF). The NSACF refers to a network function that is configured to control and restrict the number of UEs and/or packet data unit (PDU) sessions registered to a particular network slice. To provide an example, the NSACF may perform various operations related to enforcing a quota for a maximum number of UEs registered to a particular network slice (e.g., S-NSSAI). A NSACF service area is related to the location of the network function consumer. However, reference to the term NSACF is merely provided for illustrative purposes.

For one S-NSSAI, there is only one configured global maximum allowed number value (e.g., number of UEs and/or PDU sessions) for NSAC. However, it is possible more than one service area is associated with one S-NSSAI, e.g., a PLMN is split into multi-service areas. This impacts the NSAC because there will be more than one NSACF handling the UE. Thus, there should be a manner of consistent NSAC handling against the configured global maximum allowed number across the multiple NSACFs.

This scenario of multiple NSACFs may include multiple use cases and the exemplary embodiments may be implemented based on any of these use cases. In a first exemplary use case, multiple NSACFs are deployed within one PLMN where more than one service area is defined within the PLMN. For each service area one NSACF or NSACF set is selected for slice admission control and includes control of the maximum allowed number of UEs or PDU sessions.

A second exemplary use case is related to roaming where a user resides at a visited PLMN (VPLMN). The NSAC (e.g., maximum number of UEs/PDU sessions) may be controlled by an NSACF in the VPLMN (e.g., for a local breakout (LBO) PDU session), or an NSACF in the home PLMN (HPLMN) (e.g., for a home routed (HR) PDU session).

A third exemplary use case is related to an Evolved Packet System (EPS) interworking scenario. When a user establishes an HR PDN connection at the EPS network and then moves to an NR network later, the NSACF selected by the Session Management Function (SMF)+Packet Data Network Gateway (PGW-C) (e.g., of the EPS) and the Access and Mobility Management Function (AMF) (e.g., of the NR network) may be different.

It should be understood that these use cases are only exemplary and that the exemplary embodiments may be used in any scenario where more than one NSACF is controlling access to a network slice.

In one aspect, the exemplary embodiments relate to a hierarchical NSACF architecture for enforcing maximum UE/PDU session number control. The hierarchical NSACF architecture includes a primary NSACF responsible for enforcing the overall maximum number of UEs/PDU sessions for a network slice and one or more local NSACFs that are responsible for enforcing a local maximum number of UEs/PDU sessions. This hierarchical NSACF architecture allows the primary NSACF to dynamically reallocate the number of UEs/PDU sessions among the various local NSACFs.

In another aspect, the exemplary embodiments introduce an on-demand network slice. Network slices that are identified as on-demand allow a UE to delay registration for the network slice until the UE identifies that the UE is to access the on-demand slice. This access mechanism is based on an interworking between the network slice being identified to the UE as an on-demand slice and User Equipment Route Selection Policy (URSP) rules that indicate a Route Selection Descriptor for the network slice. Specific examples of these exemplary mechanisms are described in detail below.

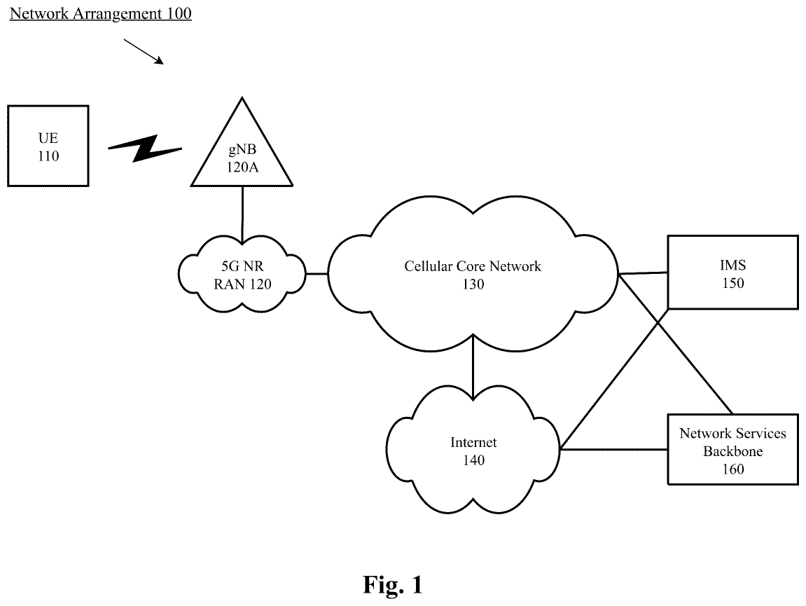

FIG. 1 shows an exemplary network arrangement 100 according to various exemplary embodiments. The exemplary network arrangement 100 includes the UE 110. Those skilled in the art will understand that the UE 110 may be any type of electronic component that is configured to communicate via a network, e.g., mobile phones, tablet computers, desktop computers, smartphones, phablets, embedded devices, wearables, Internet of Things (IoT) devices, etc. It should also be understood that an actual network arrangement may include any number of UEs being used by any number of users. Thus, the example of a single UE 110 is merely provided for illustrative purposes.

The UE 110 may be configured to communicate with one or more networks. In the example of the network arrangement 100, the network with which the UE 110 may wirelessly communicate is a 5G new radio (NR) radio access network (RAN) 120. However, the UE 110 may also communicate with other types of networks (e.g., 5G cloud RAN, a next generation RAN (NG-RAN), long term evolution (LTE) RAN, a legacy cellular network, a wireless local area network (WLAN), etc.) and the UE 110 may also communicate with networks over a wired connection. Therefore, in this example, the UE 110 may have a 5G NR chipset to communicate with the 5G NR RAN 120.

The 5G NR RAN 120 may be a portion of a cellular network that may be deployed by cellular providers (e.g., Verizon, AT & T, T-Mobile, etc.). The 5G NR RAN 120 may include, for example, cells or base stations (Node Bs, eNodeBs, HeNBs, eNBS, gNBs, gNodeBs, macrocells, microcells, small cells, femtocells, etc.) that are configured to send and receive traffic from UEs that are equipped with the appropriate cellular chip set. In network arrangement 100, the 5G NR RAN 120 is shown with a gNB 120A. However, an actual network arrangement may include any number of different types of base stations or cells deployed by any number of RANs. Thus, the example of a single 5G NR RAN 120 and a single gNB 120A is merely provided for illustrative purposes.

Those skilled in the art will understand that any association procedure may be performed for the UE 110 to connect to the 5G NR RAN 120. For example, as discussed above, the 5G NR RAN 120 may be associated with a particular network carrier where the UE 110 and/or the user thereof has a contract and credential information (e.g., stored on a SIM card). Upon detecting the presence of the 5G NR RAN 120, the UE 110 may transmit the corresponding credential information to associate with the 5G NR RAN 120. More specifically, the UE 110 may associate with a specific base station or cell (e.g., gNB 120A).

The network arrangement 100 also includes a cellular core network 130, the Internet 140, an IP Multimedia Subsystem (IMS) 150, and a network services backbone 160. The cellular core network 130 may be considered to be the interconnected set of components that manages the operation and traffic of the cellular network. It may include the evolved packet core (EPC) and/or the 5G core (5GC). The cellular core network 130 also manages the traffic that flows between the cellular network and the Internet 140. The IMS 150 may be generally described as an architecture for delivering multimedia services to the UE 110 using the IP protocol. The IMS 150 may communicate with the cellular core network 130 and the Internet 140 to provide the multimedia services to the UE 110. The network services backbone 160 is in communication either directly or indirectly with the Internet 140 and the cellular core network 130. The network services backbone 160 may be generally described as a set of components (e.g., servers, network storage arrangements, etc.) that implement a suite of services that may be used to extend the functionalities of the UE 110 in communication with the various networks.

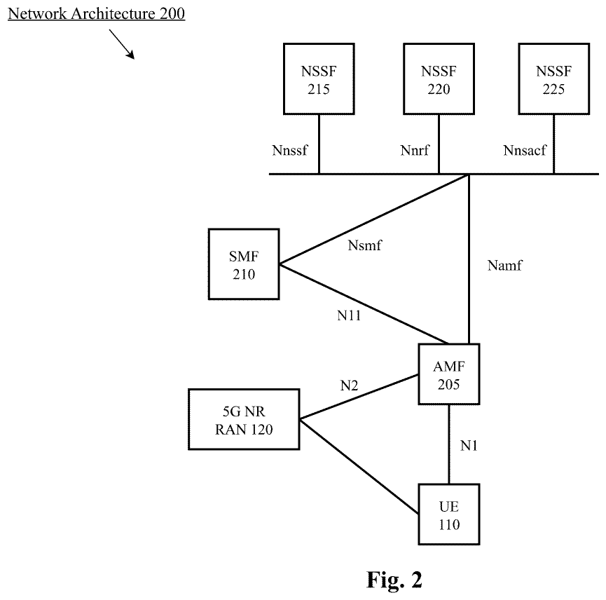

FIG. 2 shows an exemplary network architecture 200 according to various exemplary embodiments. The following description will provide a general overview of the various components of the exemplary architecture 200. The specific operations performed by the components with respect to the exemplary embodiments will be described in greater detail after the description of the architecture 200.

Those skilled in the art will understand that the components of the exemplary architecture 200 may reside in various physical and/or virtual locations relative to the network arrangement 100 of FIG. 1. These locations may include, within the access network (e.g., RANs 120), within the core network 130, as separate components outside of the locations described with respect to FIG. 1, etc.

In FIG. 2, the various components are shown as being connected via connections labeled Nx (e.g., N1, N2, N11, Nsmf, Namf, Nnssf, Nnrf, Nnsacf, etc.). Those skilled in the art will understand that each of these connections (or interfaces) are defined in the 3GPP Specifications. The exemplary architecture 200 is using these connections in the manner in which they are defined in the 3GPP Specifications. Furthermore, while these interfaces are termed connections throughout this description, it should be understood that these interfaces are not required to be direct wired or wireless connections, e.g., the interfaces may communicate via intervening hardware and/or software components. To provide an example, the UE 110 may exchange signals over the air with the cell 120A. However, in the architecture 200 the UE 110 is shown as having a connection to the AMF 205. This connection or interface is not a direct communication link between the UE 110 and the AMF 205, but is a connection that is facilitated by intervening hardware and software components. Thus, throughout this description the terms “connection” and “interface” may be used interchangeably to describe the Nx interface between the various components.

The architecture 200 includes the UE 110 and the 5G NR RAN 120. The UE 110 and the 5G NR RAN 120 are connected to the AMF 205. The AMF 205 is generally responsible for connection and mobility management in the 5G NR RAN 120. For example, the AMF 205 may perform operations related to registration procedure management between the UE 110 and the core network 130. The exemplary embodiments are not limited to an AMF that performs the above reference operations. Those skilled in the art will understand the variety of different types of operations an AMF may perform. Further, reference to a single AMF 205 is merely for illustrative purposes, an actual network arrangement may include any appropriate number of AMFs.

The AMF 205 is connected to the session management function (SMF) 210. The SMF 210 may perform operations related to session management such as, but not limited to, session establishment, session release, IP address allocation, policy and quality of service (QOS) enforcement, etc. The exemplary embodiments are not limited to an SMF that performs the above reference operations. Those skilled in the art will understand the variety of different types of operations a SMF may perform. Further, reference to a single SMF 210 is merely for illustrative purposes, an actual network arrangement may include any appropriate number of SMFs.

The AMF 205 and the SMF 210 are also connected to the network slice selection function (NSSF) 215, the network resource function (NRF) 220 and the NSACF 225. The NSSF 215 performs operations related to network slicing. For example, the NSSF 215 may select a set of network slice instances configured to be used by the UE 110 or serving the UE 110. The NSSF 215 may also manage one or more databases that include a mapping table of S-NSSAI and the frequency bands in which the S-NSSAI is allowed to operate. The NRF 220 may perform operations related to network service discovery functionality which allows network functions to determine where and how to access other network functions. However, reference to the term network resource function is merely provided for illustrative purposes. Different networks may refer to a similar entity by a different name, for example, 3GPP networks may use the terms network resource function and network repository function interchangeably.

The NSACF 225 may be configured to perform operations related to controlling the number of UEs and/or sessions registered per network slice for network slices that are subject to NSAC. During operation, the NSACF 225 may check a count of registered UEs and/or PDU sessions with the S-NSSAI and determine whether the network slice quota has been reached. The NSACF 225 may then accept or reject the register request based on the count and the quota. However, reference to a quota concept is merely provided for illustrative purposes. Those skilled in the art will understand that different entities may refer to similar concepts by a different name. For example, 3GPP networks may use the terms quota and admission control to refer to the same concept. Further, reference to a single NSACF 225 is merely for illustrative purposes, an actual network arrangement may include any appropriate number of NSACFs.

To provide a more specific example, the NSACF 225 may be configured with a maximum number of PDU session per network slice that are allowed to be served by multiple network slices that are subject to NSAC. During operation, the SMF 210 may be triggered to send a request to the NSACF 225 for a maximum number of PDU sessions per network slice admission control during PDU session establishment/release procedures. The NSACF 225 may control (e.g., increase, decrease, etc.) the current number of PDU sessions per network slice such that it does not exceed the maximum number of PDU sessions allowed to be served by that network slice. When the current number of PDU sessions with the network slice is to be increased, the NSACF 225 may check whether the maximum number of PDU sessions per network slice for that network slice has already been reached. The NSACF 225 may then accept or reject the request based on the count and the quota.

To provide another example, the NSACF 225 may be configured with a maximum number of UEs per network slice which are allowed to be served by each network slice that is subject to NSAC. During operation, the AMF 205 may be triggered to send a request to the NSACF 225 for a maximum number of UEs per network slice admission control when the UE's registration status for a network slice subject to NSAC may change. The registration status may change during procedures such as, but not limited to, a UE registration procedure, a UE deregistration procedure, a network slice-specific authentication and authorization procedure, an authentication authorization and accounting (AAA) server triggered network slice-specific re-authorization and re-authorization procedure and a AAA server triggered slice-specific authorization revocation. As indicated above, the NSACF 225 may control (e.g., increase, decrease, etc.) the current number of UEs registered with a network slice such that it does not exceed the maximum number of UEs allowed to register with that slice. The NSACF 225 may also maintain a list of UE IDs registered with a network slice that is subject to NSAC. When the current number of UEs registered with a network slice is to be increased, the NSACF 225 may first check whether the UE identity is already in the list of UEs registered with that network slice. If not, the NSACF 225 may check whether the maximum number of UEs per network slice for that particular network slice has already been reached. The NSACF 225 may then accept or reject the request based on the count and the quota.

As described above, there may be scenarios where more than one NSACF is controlling access to a network slice. The exemplary embodiments provide a hierarchical NSACF architecture for maximum UE/PDU session number control. In these exemplary embodiments, one of the NSACFs is designated as the primary NSACF for the network slice and is responsible for enforcing the global maximum UE/PDU session number. The other NSACFs are designated as local NSACFs to which the UE sends a registration request for the network slice and the local NSACF is responsible for enforcing a local maximum UE/PDU session number.

To provide an example for illustrative purposes, there may be one primary NSACF and four (4) local NSACFs for a network slice. The primary NSACF may allocate the maximum UE/PDU session number equally among the local NSACFs, e.g., each local NSACF receives 25% of the maximum UE/PDU session number. It should be understood that this is only an example and that there may any number of local NSACFs, the primary NSACF may allocate the maximum UE/PDU session number in any manner (i.e., it is not required that the allocation be equal) and the primary NSACF may also act as one of the local NSACFs but that is not a requirement.

Throughout this description, the term “quota” will be used to describe the maximum number of UEs and/or PDU sessions that are allowed for a S-NSSAI. The quota may be described as a “global quota,” e.g., the maximum number of UEs and/or PDU sessions that are allowed for a S-NSSAI across all NSACFs that support the S-NSSAI, or a “local quota,” e.g., the maximum number of UEs and/or PDU sessions that are allowed for a S-NSSAI for an individual (or set) of local NSACFs that support the S-NSSAI in a service area. The local quota is a subset of the global quota.

The above example may illustrate one or more issues with this hierarchical NSACF architecture. For example, there may be one local NSACF which is out of the assigned quota, while other local NSACFs have sufficient quota still remaining. Thus, this one local NSACF may reject a request from a UE to access the network slice when the global maximum has not been met. This may cause inefficient overall S-NSSAI usage where users are unable to take full benefit of the S-NSSAI. Thus, the exemplary embodiments are further related to the primary NSACF being able to control the maximum quota by dynamically reallocating quota to the local NSACFs as needed.

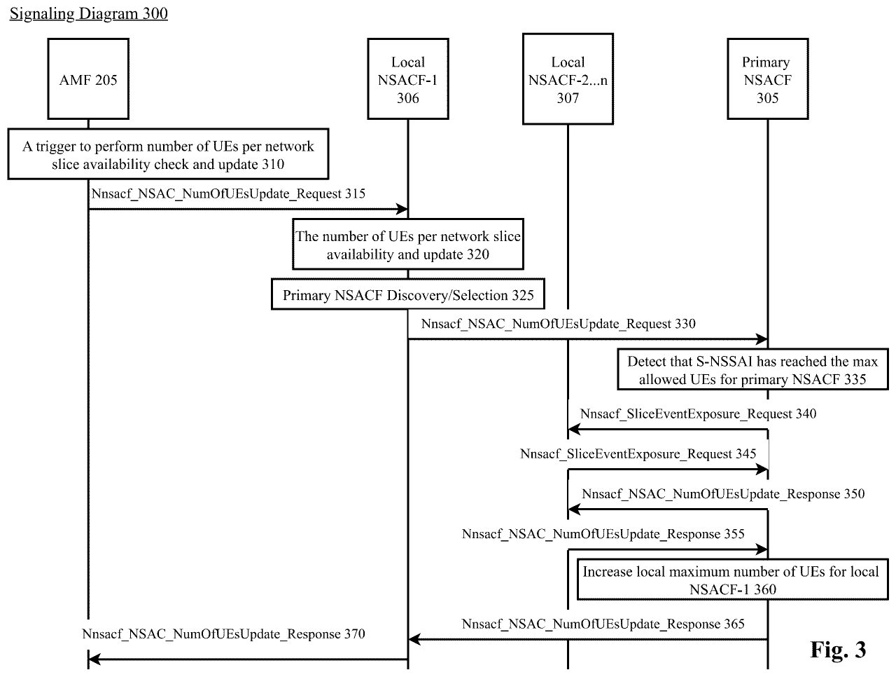

FIG. 3 shows a first exemplary signaling diagram 300 showing a primary NSACF dynamically reallocating quota to local NSACFs according to various exemplary embodiments. In the example of FIG. 3, the signaling is performed between the AMF 205, the primary NSACF 305, a first local NSACF 306 and second local NSACFs 307. The second local NSACFs 307 may include one or more NSACFs. As described above, each of the NSACFs 305, 306 and 307 are responsible for an aspect of NSAC for a S-NSSAI, e.g., the primary NSACF 305 is responsible for enforcing the global maximum quota and the local NSACFs 306 and 307 are responsible for enforcing a local quota. In the below description of the signaling diagram 300, specific names are provided for various messages that are exchanged between the entities in the signaling diagram 300. However, it should be understood that these names are only exemplary and the information and/or functionality associated with these messages may be conveyed in a message of another name or even multiple messages.

In 310, the AMF 205 may receive a trigger to perform a number of UEs per network slice availability check and update. For example, a UE may want to access a network slice and the AMF 205 is triggered to perform the check to determine if the UE may access the desired network slice. In 315, the AMF 205 sends an Nnsacf_NSAC_NumOfUEsUpdate_Request to the first local NSACF 306 to determine the network slice availability. It should be understood that the AMF 205 has been previously configured to understand the NSACF that is controlling the NSAC for the network slice in the current service area of the UE.

In 320, the first local NSACF 306 performs the network slice availability check. In this example, it may be considered that the first local NSACF 306 is out of the local quota for this network slice. However, as described above, this does not mean that the global quota has been exhausted. As shown in 325, the first local NSACF 306 has performed a discovery/selection procedure to understand the primary NSACF 305 for this network slice. This discovery/selection procedure 325 may have been performed prior to the first local NSACF 306 performing the slice availability check.

In 330, the first local NSACF 306 may check with the primary NSACF 305 to determine if there is any maximum quota still available that may be allocated to the first local NSACF 306. This check may be accomplished by sending a Nnsacf_NSAC_NumOfUEsUpdate_Request from the first local NSACF 306 to the primary NSACF 305 with information indicating the first local NSACF 306 has reached the local quota limit.

In 335, the primary NSACF 305 determines that the first local NSACF 306 has reached the maximum local quota for the S-NSSAI based on the information included in the Nnsacf_NSAC_NumOfUEsUpdate_Request 330. The primary NSACF 305 also determines that the maximum global quota has been reached. It should be understood that this determination does not mean that all of the global quota is being used. Rather, this determination indicates that all of the global quota has been allocated to the individual local NSACFs 306, 307. In the example described above, the primary NSACF allocated 100% of the available global quota. In some exemplary embodiments, the primary NSACF 305 may allocate less than 100% of the global quota and reserve some of the global quota for reallocation without having to deallocate any local quota from the second NSACFs 307. However, in this example, it may be considered that 100% of the available global quota has been allocated to the local NSACFs 306, 307 and any dynamic reallocation scheme will include deallocating local quota from one or more of the second local NSACFs 307.

In 340, the primary NSACF 305 queries the second local NSACFs 307 to determine the current number of UEs/PDU sessions registered for the S-NSSAI. The primary NSACF 305 may perform this query be sending each of the second local NSACFs 307 a Nnsacf_SliceEventExposure_Request. In 345, each of the second local NSACFs 307 may send the primary NSACF 305 a Nnsacf_SliceEventExposure_Response indicating the current number of UEs/PDU sessions registered for the S-NSSAI. It should be understood that the primary NSACF 305 will individually query each of the second local NSACFs 307.

Thus, at this point of the signaling, the primary NSACF 305 has information as to the current number of UEs/PDU sessions registered for the S-NSSAI across all of the local NSACFs (e.g., the first local NSACF 306 and the second local NSACFs 307). The primary NSACF 305 may then compare this number to the maximum quota to determine whether the maximum quota for the S-NSSAI has been reached. In this example, it may be considered that the global quota has not been reached. Thus, primary NSACF 305 may dynamically reallocate the maximum quota among the local NSACFs 306, 307.

It should be understood that the primary NSACF 305 may perform the quota reallocation in any number of manners. For example, the primary NSACF 305 may deallocate a single UE/PDU session from the quota of one of the second local NSACFs 307 that has remaining quota to reallocate to the first local NSACF 306. In another example, the primary NSACF 305 may understand that one of the second local NSACFs 307 is underutilizing the assigned local quota and the primary NSACF 305 may deallocate multiple UEs/PDU sessions from the quota of this second local NSACF 307 to reallocate to the first local NSACF 306. In a further example, the primary NSACF 305 may deallocate quota from multiple second local NSACFs 307 to reallocate to the first local NSACF 306. In some exemplary embodiments, the primary NSACF 305 may implement a local quota usage threshold that is less than the maximum of the local quota. This local quota usage threshold may indicate if the second local NSACF 307 is underutilizing the local quota. For example, if the current number of UEs/PDU sessions registered for the S-NSSAI at a second local NSACF 307 is less than the local quota usage threshold, this second local NSACF 307 may be a candidate for deallocation. In addition, as will be described below in other exemplary embodiments, the primary NSACF 305 may use this gathered quota information to preemptively reallocate quota before any of the local NSACFs 306, 307 reach the local maximum.

To perform the reallocation, in 350, the primary NSACF 305 may send a Nnsacf_NSAC_NumOfUEsUpdate_Request to the one or more second local NSACFs 307 that will have their local quota deallocated. The information included in the Nnsacf_NSAC_NumOfUEsUpdate_Request 350 will indicate to each of the one or more second local NSACFs 307 the number of UEs/PDU sessions to deallocate from the local quota. In 355, one or more second local NSACFs 307 will respond to the primary NSACF 305 with a Nnsacf_NSAC_NumOfUEsUpdate_Response indicating that the one or more second local NSACFs 307 have updated the corresponding local quota.

When the primary NSACF 305 has received the update response indicating the one or more second local NSACFs 307 have updated the corresponding local quota, in 360, the primary NSACF may increase the local quota for the first local NSACF 306 by the corresponding number that has been deallocated from the one or more second local NSACFs 307. This increase in the local quota may be indicated by the primary NSACF 305 to the first local NSACF 306 using a Nnsacf_NSAC_NumOfUEsUpdate_Response 365 that includes information updating the local quota. The first local NSACF 306 may then provide a Nnsacf_NSAC_NumOfUEsUpdate_Response 370 to the AMF 205 indicating that the local quota has been updated. This will signal to the AMF 205 that the UE that is permitted to access the requested S-NSSAI.

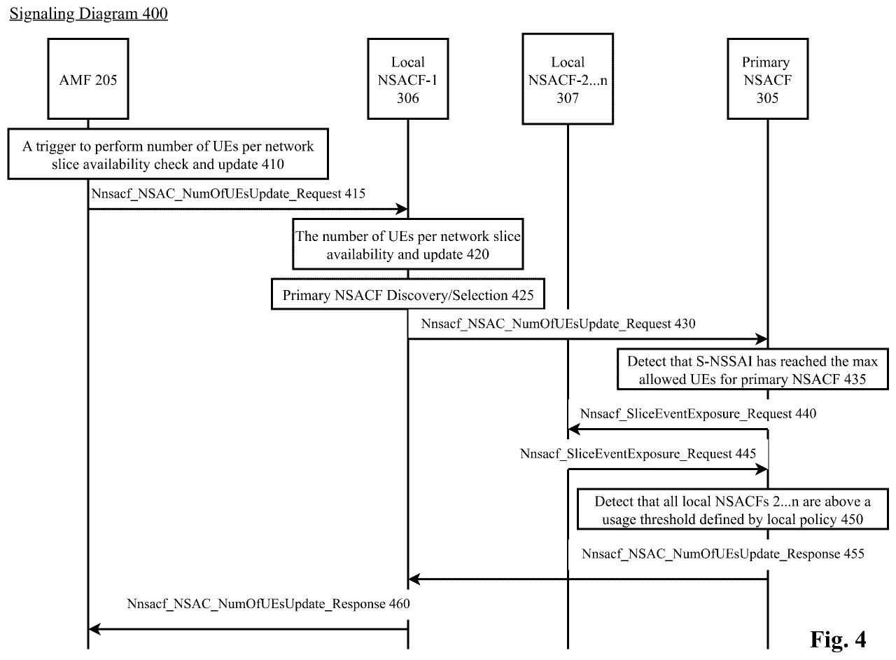

FIG. 4 shows a second exemplary signaling diagram 400 showing a primary NSACF dynamically reallocating quota to local NSACFs according to various exemplary embodiments. The entities involved in the signaling diagram 400 are the same entities as described for the signaling diagram 300. In addition, many of the operations and messages in signaling diagram are identical to the operations and/or messages in the signaling diagram 300. Thus, these operations and/or messages will be identified but will not be described for a second time. As will become clear from the below description, the difference between the signaling diagram 300 and the signaling diagram 400 is that in the signaling diagram 300 there is global quota that is able to be dynamically reallocated by the primary NSACF 305, whereas in signaling diagram 400 there is no available global quota to be reallocated.

The signaling and operations 410-445 is the same as the signaling and operations 310-340 of signaling diagram 300. However, in 450, the primary NSACF 305 may determine (based on the Nnsacf_SliceEventExposure_Response 445 from each of the second local NSACFs 307) that the second local NSACFs 307 do not have any quota to be deallocated. It should be understood that this does not require that each of the second local NSACFs 307 has reached the maximum local quota. While this may be true in some scenarios, in other scenarios each of the second local NSACFs 307 may be above the local quota usage threshold and the primary NSACF 305 may not want to deallocate any quota from second local NSACFs 307 that are above the local quota usage threshold even though one or more of the second local NSACFs 307 have not reached the maximum local quota.

In 455, the primary NSACF 305 will send a Nnsacf_NSAC_NumOfUEsUpdate_Response to the first local NSACF 306 indicating that the maximum number of UEs registered with the network slice has been reached. From this message, the first local NSACF 306 will understand that the primary NSACF does not have any additional quota to reallocate to the first local NSACF 306. Thus, in 460, the first local NSACF 306 will send a Nnsacf_NSAC_NumOfUEsUpdate_Response to the AMF 205 indicating the maximum number of UEs registered with the network slice has been reached. This will signal to the AMF 205 that the UE that is not permitted to access the requested S-NSSAI.

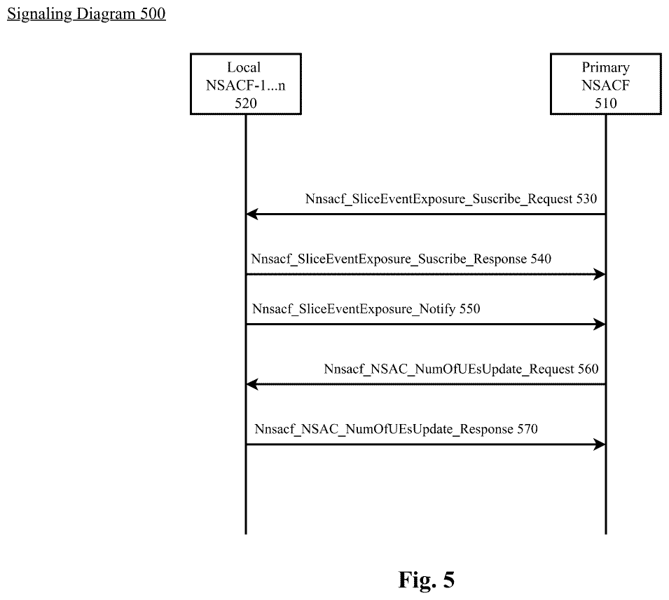

FIG. 5 shows a third exemplary signaling diagram 500 showing a primary NSACF dynamically reallocating quota to local NSACFs according to various exemplary embodiments. The difference between the signaling diagrams 300, 400 and the signaling diagram 500 is that the dynamic reallocation in signaling diagrams 300, 400 is based on an on-demand method, e.g., when a local NSACF runs out of quota, the local NSACF requests additional quota from the primary NSACF. In contrast, the signaling diagram 500 shows a dynamic reallocation scheme that is based on a periodic load balancing performed by the primary NSACF. The entities involved in the signaling in FIG. 5 are the primary NSACF 510 and two or more local NSACFs 520.

In 530, the primary NSACF 510 sends a Nnsacf_SliceEventExposure_Subscribe_Request to each of the local NSACFs 520. This requests that each of the local NSACFs 520 subscribe to the primary NSACF 510 to periodically report the current number of UEs/PDU sessions registered for an S-NSSAI identified in the subscribe request. In this example, it may be considered that each of the local NSACFs 520 respond to the primary NSACF 510 in 540 using a Nnsacf_SliceEventExposure_Subscribe_Response indicating that the corresponding local NSACF 520 will periodically report the current number of UEs/PDU sessions registered for the identified S-NSSAI.

In 550, each of the local NSACFs 520 will report the current number of UEs/PDU sessions registered for the identified S-NSSAI. The subscription request 530 may indicate the periodicity of the reporting such as every X minutes or any other time frame. In other exemplary embodiments, the reporting may be triggered by a specific network event.

Thus, at this point of the signaling, the primary NSACF 510 has information as to the current number of UEs/PDU sessions registered for the S-NSSAI across each of the local NSACFs 520. The primary NSACF 305 may then compare this number to the local quota usage threshold to determine the utilization by each of the local NSACFs 520 of the allocated quota.

For those local NSACFs 520 that are below the local quota usage threshold, the primary NSACF 510 may deallocate some of the quota from these local NSACFs 520. This deallocation may be performed by the primary NSACF 305 sending each of the local NSACFs 520 that are to have quota deallocated a Nnsacf_NSAC_NumOfUEsUpdate_Request 560 to indicate the updated local quota for the local NSACF 520. In 570, each of the local NSACFS 520 that have had the local quota deallocated may respond in a Nnsacf_NSAC_NumOfUEsUpdate_Response to indicate to the primary NSACF 510 that the local quota has been updated.

In some exemplary embodiments, the local quota that has been deallocated from the local NSACFs 520 may be reserved by the primary NSACF 510 to be reallocated as needed. In other exemplary embodiments, the primary NSACF 510 may immediately reallocate the deallocated quota to one or more local NSACFs 520 that are approaching the local maximum.

As described above, another issue related to network slicing is that a UE may choose to register with all the Configured NSSAIs and then use user equipment route selection policy (URSP) rules to decide which data network names (DNNs) to connect to at run time. Thus, a UE may register with one or more slices that it will not use or in even some cases, the Configured NSSAIs may include NSSAIs that are not in the Allowed NSSAIs. In these cases, the UE is counted against the quota for each NSSAI with which it is registered even when the UE is not using or will never use the network slice.

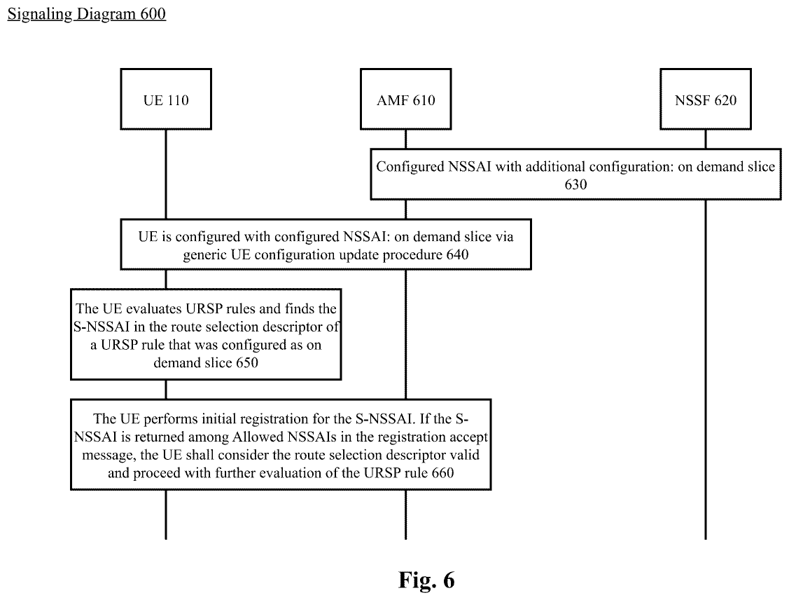

The exemplary embodiments introduce the concept of an on-demand slice which may be included as part of the Configured NSSAI. The concept of the on-demand slice is described with reference to the signaling diagram of FIG. 6.

FIG. 6 shows a signaling diagram 600 illustrating the concept of an on-demand slice according to various exemplary embodiments. The entities involved in the signaling diagram 600 include the UE 110, the AMF 610 and the NSSF 620. The signaling diagram 600 is based on a registration that the UE 110 is performing with the AMF 610 that includes network slices that are identified by the NSSF. As described above, the NSSF 620 manages one or more databases that include a mapping table of S-NSSAI and the frequency bands in which the S-NSSAI is allowed to operate.

In 630, the NSSF 620 provides the AMF 610 with a list of Configured NSSAI. The information provided by the NSSF 620 also includes an indication of whether each NSSAI in the list of Configured NSSAI is an on-demand NSSAI. In 640, the AMF 610 configures (e.g., via a configuration update procedure) the UE 110 with the Configured NSSAI list including the indication of whether a NSSAI is an on-demand NSSAI.

The UE 110, upon receiving the Configured NSSAI, will not attempt to register for any of the Configured NSSAI that are indicated as on-demand NSSAIs. Rather, in 650, the UE will evaluate URSP rules to determine if an on-demand S-NSSAI is in the Route Selection Descriptor of a URSP rule.

In 660, the UE 110 will include any on-demand S-NSSAI that is included in the Route Selection Descriptor of a URSP rule in an initial registration request with the AMF 610. If the S-NSSAI is returned among the Allowed NSSAIs in the registration accept message, the UE 110 will further evaluate the Route Selection Descriptor of the URSP rule and consider it valid if the S-NSSAI was present in the Allowed NSSAIs.

Thus, by using the signaling of FIG. 6, it can be seen that the UE 110 will register or deregister with a network slice based on UE policy. This results in the UE only registering with a S-NSSAI when it is actually needed to have connectivity to the related network slice.

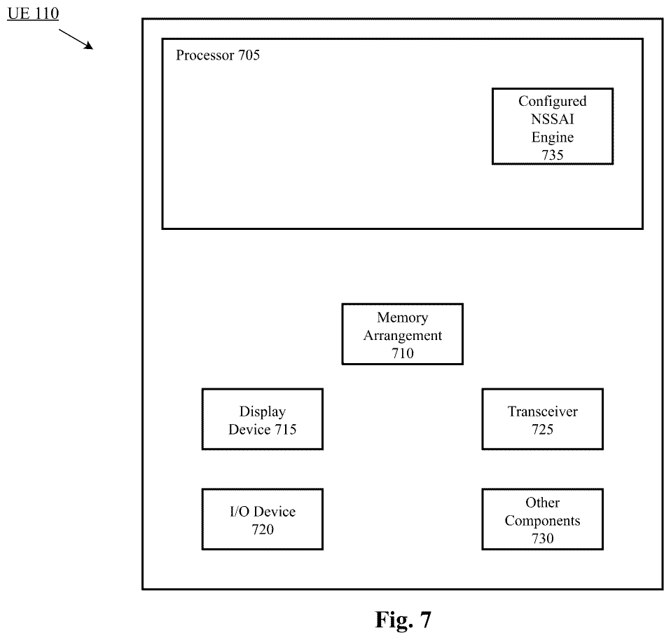

FIG. 7 shows an exemplary UE 110 according to various exemplary embodiments. The UE 110 may include a processor 705, a memory arrangement 710, a display device 715, an input/output (I/O) device 720, a transceiver 725 and other components 730. The other components 730 may include, for example, an audio input device, an audio output device, a power supply, a data acquisition device, ports to electrically connect the UE 110 to other electronic devices, etc.

The processor 705 may be configured to execute a plurality of engines of the UE 110. For example, the engines may include a Configured NSSAI engine 735. The Configured NSSAI engine 735 may perform various operations related to on-demand network slicing as was described above with reference to the UE 110 operation in FIG. 6.

The above referenced NSSAI engine 735 being an application (e.g., a program) executed by the processor 705 is merely provided for illustrative purposes. The functionality associated with the NSSAI engine 735 may also be represented as a separate incorporated component of the UE 110 or may be a modular component coupled to the UE 110, e.g., an integrated circuit with or without firmware. For example, the integrated circuit may include input circuitry to receive signals and processing circuitry to process the signals and other information. The engines may also be embodied as one application or separate applications. In addition, in some UEs, the functionality described for the processor 705 is split among two or more processors such as a baseband processor and an applications processor. The exemplary embodiments may be implemented in any of these or other configurations of a UE.

The memory arrangement 710 may be a hardware component configured to store data related to operations performed by the UE 110. The display device 715 may be a hardware component configured to show data to a user while the I/O device 720 may be a hardware component that enables the user to enter inputs. The display device 715 and the I/O device 720 may be separate components or integrated together such as a touchscreen. The transceiver 725 may be a hardware component configured to establish a connection with the 5G NR-RAN 120 and/or any other appropriate type of network. Accordingly, the transceiver 725 may operate on a variety of different frequencies or channels (e.g., set of consecutive frequencies).

### EXAMPLES

In a first example, a method, comprising determining a global quota comprising a first number of user equipments (UEs) or protocol data unit (PDU) sessions that are allowed to be registered to a network slice, receiving, from a first local NSACF, an indication of a second number of UEs or PDU sessions currently registered to the network slice by the first local NSACF, wherein the first local NSACF is configured with a first local quota comprising a third number of UEs or PDU sessions that are allowed to be registered to the network slice by the first local NSACF, comparing the second number to a local quota usage threshold for the first local NSACF and determining, based on the comparing, whether the first local quota for the first local NSACF is to be updated by decreasing the third number.

In a second example, the method of the first example, further comprising receiving an update request from a second local NSACF indicating the second NSACFs has reached a second local quota comprising a fourth number of UEs or PDU sessions that are allowed to be registered to the network slice by the second local NSACF and determining the primary NSACF does not have a global quota to allocate to the second NSACF.

In a third example, the method of the second example, further comprising sending a request to the first local NSACF to report the second number, wherein the request is triggered based on the receiving the update request from the second local NSACF and determining the primary NSACF does not have a global quota to allocate to the second NSACF.

In a fourth example, the method of the second example, wherein the first local quota is updated when the second number is less than the local quota usage threshold.

In a fifth example, the method of the fourth example, wherein updating the first local quota comprises sending an update message to the first local NSACF to update the first local quota by decreasing the third number and receiving an update response from the first local NSACF indicating the first local quota has been updated.

In a sixth example, the method of the fifth example, further comprising determining the second local quota is to be updated by increasing the fourth number, wherein an increase of the fourth number corresponds to a decrease of the third number and sending an update response to the second local NSACF to update the second local quota by increasing the fourth number.

In a seventh example, the method of the second example, wherein the first local quota is not updated when the second number is greater than the local quota usage threshold.

In an eighth example, the method of the seventh example, further comprising sending an update response to the second local NSACF to indicate the second local quota is not to be updated.

In a ninth example, one or more processors configured to perform any of the methods of the first through eighth examples.

In a tenth example, a primary network slice admission control function (NSACF) configured to perform any of the methods of the first through eighth examples.

In an eleventh example, a method comprising receiving, from an access and mobility control function (AMF), a first update request indicating a first number of user equipments (UEs) or protocol data unit (PDU) sessions currently registered to a network slice by the local NSACF should be incremented, determining the first number of UEs or PDU sessions will exceed a local quota comprising a second number of UEs or PDU sessions that are allowed to be registered to the network slice by the local NSACF and sending, to a primary NSACF, a second update request from a second local NSACF indicating the first number should be incremented.

In a twelfth example, the method of the eleventh example, further comprising receiving, from the primary NSACF, a first update response to the second update request indicating the local NSACF is to update the local quota by increasing the second number, incrementing the first number and sending, to the AMF, a second update response indicating the first number has been incremented.

In a thirteenth example, the method of the eleventh example, further comprising receiving, from the primary NSACF, a first update response to the second update request indicating the first number is not incremented and sending, to the AMF, a second update response indicating the first number is not incremented.

In a fourteenth example, one or more processors configured to perform any of the methods of the eleventh through thirteenth examples.

In a fifteenth example, a local network slice admission control function (NSACF) configured to perform any of the methods of the eleventh through thirteenth examples.

In a sixteenth example, a method comprising receiving, from a primary NSACF, a request to indicate a first number of user equipments (UEs) or protocol data unit (PDU) sessions currently registered to a network slice by the local NSACF, wherein the local NSACF is configured with a local quota comprising a second number of UEs or PDU sessions that are allowed to be registered to the network slice by the local NSACF and sending, to the primary NSACF, a response indicating the first number.

In a seventeenth example, the method of the sixteenth example, further comprising receiving, from the primary NSACF, an update request to update the local quota by decreasing the second number and sending, to the primary NSACF, an update response indicating the local quota has been updated.

In an eighteenth example, one or more processors configured to perform any of the methods of the sixteenth through seventeenth examples.

In a nineteenth example, a local network slice admission control function (NSACF) configured to perform any of the methods of the sixteenth through seventeenth examples.

In a twentieth example, a method comprising receiving, from each of a plurality of local NSACFs, a report indicating a first number of user equipments (UEs) or protocol data unit (PDU) sessions currently registered to a network slice by the local NSACF, comparing the first number to a local quota usage threshold for each of the local NSACFs, wherein the local quota usage threshold is based on a local quota for each of the local NSACFs comprising a second number of UEs or PDU sessions that are allowed to be registered to the network slice by a corresponding local NSACF and determining, based on the comparing, whether the local quota for one or more of the local NSACFs is to be updated.

In a twenty first example, the method of the twentieth example, wherein updating the local quota comprises decreasing the second number.

In a twenty second example, the method of the twenty first example, further comprising sending, to the one or more local NSACFs that are to be updated, an update request indicating the local quota is to be updated comprising an indication that the second number is to be decreased and receiving, from the one or more local NSACFs that are to be updated, an update response indicating the local quota is updated.

In an twenty third example, one or more processors configured to perform any of the methods of the twentieth through twenty second examples.

In a twenty fourth example, a primary network slice admission control function (NSACF) configured to perform any of the methods of the twentieth through twenty second examples.

In a twenty fifth example, a method, comprising receiving, from an access and mobility function (AMF), a list of configured network slices, wherein one or more of the configured network slices are identified as on-demand network slices, evaluating User Equipment Route Selection Policy (URSP) rules to determine if the URSP rules include a Route Selection Descriptor for any of the on-demand network slices, sending, to the AMF, a registration request comprising the on-demand network slices for which the URSP rules include the Route Selection Descriptor, receiving, from the AMF, a registration response comprising a list of allowed network slices and for any on-demand network slices for which the URSP rules include the Route Selection Descriptor and are on the list of allowed network slices, further evaluating the URSP rules related to the on-demand network slices.

In an twenty sixth example, one or more processors configured to perform the method of the twenty fifth example.

In an twenty seventh example, a user equipment (UE) comprising a transceiver configured to communicate with one or more networks and one or more processors communicatively coupled to the transceiver and configured to perform the method of the twenty fifth example.

Those skilled in the art will understand that the above-described exemplary embodiments may be implemented in any suitable software or hardware configuration or combination thereof. An exemplary hardware platform for implementing the exemplary embodiments may include, for example, an Intel x86 based platform with compatible operating system, a Windows OS, a Mac platform and MAC OS, a mobile device having an operating system such as iOS, Android, etc. The exemplary embodiments of the above described method may be embodied as a program containing lines of code stored on a non-transitory computer readable storage medium that, when compiled, may be executed on a processor or microprocessor.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

What is claimed:

1. A primary network slice admission control function (NSACF) configured to perform operations comprising:
determining a global quota comprising a first number of user equipments (UEs) or protocol data unit (PDU) sessions that are allowed to be registered to a network slice;
receiving, from a first local NSACF, an indication of a second number of UEs or PDU sessions currently registered to the network slice by the first local NSACF, wherein the first local NSACF is configured with a first local quota comprising a third number of UEs or PDU sessions that are allowed to be registered to the network slice by the first local NSACF;
comparing the second number to a local quota usage threshold for the first local NSACF; and
determining, based on the comparing, whether the first local quota for the first local NSACF is to be updated by decreasing the third number.

2. The primary NSACF of claim 1, wherein the operations further comprise:
receiving an update request from a second local NSACF indicating the second NSACFs has reached a second local quota comprising a fourth number of UEs or PDU sessions that are allowed to be registered to the network slice by the second local NSACF; and
determining the primary NSACF does not have a global quota to allocate to the second NSACF.

3. The primary NSACF of claim 2, wherein the operations further comprise:
sending a request to the first local NSACF to report the second number, wherein the request is triggered based on the receiving the update request from the second local NSACF and determining the primary NSACF does not have a global quota to allocate to the second NSACF.

4. The primary NSACF of claim 2, wherein the first local quota is updated when the second number is less than the local quota usage threshold.

5. The primary NSACF of claim 4, wherein updating the first local quota comprises:
sending an update message to the first local NSACF to update the first local quota by decreasing the third number; and
receiving an update response from the first local NSACF indicating the first local quota has been updated.

6. The primary NSACF of claim 5, wherein the operations further comprise:
determining the second local quota is to be updated by increasing the fourth number, wherein an increase of the fourth number corresponds to a decrease of the third number; and
sending an update response to the second local NSACF to update the second local quota by increasing the fourth number.

7. The primary NSACF of claim 2, wherein the first local quota is not updated when the second number is greater than the local quota usage threshold.

8. The primary NSACF of claim 7, wherein the operations further comprise:
sending an update response to the second local NSACF to indicate the second local quota is not to be updated.

9. A local network slice admission control function (NSACF) configured to perform operations comprising:
receiving, from an access and mobility control function (AMF), a first update request indicating a first number of user equipments (UEs) or protocol data unit (PDU) sessions currently registered to a network slice by the local NSACF should be incremented;
determining the first number of UEs or PDU sessions will exceed a local quota comprising a second number of UEs or PDU sessions that are allowed to be registered to the network slice by the local NSACF; and
sending, to a primary NSACF, a second update request from a second local NSACF indicating the first number should be incremented.

10. The local NSACF of claim 9, wherein the operations further comprise:
receiving, from the primary NSACF, a first update response to the second update request indicating the local NSACF is to update the local quota by increasing the second number;
incrementing the first number; and
sending, to the AMF, a second update response indicating the first number has been incremented.

11. The local NSACF of claim 9, wherein the operations further comprise:
receiving, from the primary NSACF, a first update response to the second update request indicating the first number is not incremented; and
sending, to the AMF, a second update response indicating the first number is not incremented.

12. A primary network slice admission control function (NSACF) configured to perform operations comprising:
receiving, from each of a plurality of local NSACFs, a report indicating a first number of user equipments (UEs) or protocol data unit (PDU) sessions currently registered to a network slice by the local NSACF;
comparing the first number to a local quota usage threshold for each of the local NSACFs, wherein the local quota usage threshold is based on a local quota for each of the local NSACFs comprising a second number of UEs or PDU sessions that are allowed to be registered to the network slice by a corresponding local NSACF; and
determining, based on the comparing, whether the local quota for one or more of the local NSACFs is to be updated.

13. The primary NSACF of claim 12, wherein updating the local quota comprises decreasing the second number.

14. The primary NSACF of claim 13, wherein the operations further comprise:
sending, to the one or more local NSACFs that are to be updated, an update request indicating the local quota is to be updated comprising an indication that the second number is to be decreased; and
receiving, from the one or more local NSACFs that are to be updated, an update response indicating the local quota is updated.
